(19) United States
(12) Patent Application Publication
(10) Pub. No.: US 2011/0056338 A1
(43) Pub. Date: Mar. 10, 2011

(54) Contractible wrench structure

(76) Inventor: Chih-Ching Hsieh, Fongyuan City (TW)

(21) Appl. No.: 12/554,966

(22) Filed: Sep. 7, 2009

(51) Int. Cl. B25B 23/16; B25G 1/04

(52) U.S. Cl. 81/177.2

(57) ABSTRACT

The present invention discloses a contractible wrench structure including a handle and a rod body, and the handle includes a containing space for accommodating the rod body, and a resilient element is installed in the containing space for abutting the rod body, and the handle includes a fixing element penetrated through a side wall of the handle, and the rod body includes a groove for allowing a peg of the fixing element to slide, and the groove is composed of a slide section, a first guide section, a second guide section, a first position limiting slot, and a second position limiting slot. With the guide of the groove, an extending or contracting status of the rod body can be adjusted.

### BACKGROUND OF THE INVENTION

1. Field of the Invention

The present invention relates to a contractible wrench, in particular to a contractible wrench structure that provides a convenient way for users to operate and contract a wrench between a handle and a rod body of the wrench.

2. Description of the Related Art

Since a contractible wrench has a specific size, manufacturers need to take the portability of the wrench and the strength required for operating the wrench to secure or remove an object into consideration, and a novel design of the contractible wrench with a feasible solution is needed.

A conventional contractible wrench generally includes a handle, a space defined in the handle, a fixing element installed outside the handle, a torque spring installed in the space, and a wrench body in contact with the torque spring. The wrench body further includes an axial guide slot formed on a surface of the wrench body, left and right interconnected slots extended from both ends of the axial guide slot respectively, and left and right positioning slots, each having an opening and extended downwardly from the vertical interconnected slots respectively.

However, the two vertical interconnected slots of the aforementioned conventional contractible wrench are spatially disposed opposite to each other, and the axial guide slot is used as a basis for separating the two positioning slots at both ends of the axial guide slot, such that when a path is provided for moving a fixing element or limiting the position of the fixing element, a user cannot intuitively adjust the wrench for a contraction or an extension between a handle and a wrench body for a convenient operation, and the user has to operate the wrench with a trial and error approach before the user has a correct hand feel of the operation.

### SUMMARY OF THE INVENTION

Therefore, it is a primary objective of the present invention to provide a contractible wrench structure with a design that allows a user to position a rod body of the wrench at a second guide section and a second position limiting slot, which are symmetric to a first guide section and a first position limiting slot respectively, so that the user can contract or extend the wrench between its handle and rod body to obtain a convenient operation.

To achieve the foregoing objective, the present invention provides a contractible wrench structure, comprising:

a handle, having a containing space defined therein and interconnected to one end of the handle only, and a hole formed at an appropriate position proximate to an interconnected external surface of the handle for installing a fixing element, and an end of the fixing element being protruded towards the containing space and extended into the containing space;

a resilient element, installed in the containing space, and an end of the resilient element being stopped inside the containing space;

a rod body, being propped by another end of the resilient element, and having a driving head disposed at an end of the rod body and away from the containing space, and another end of the rod body being contained into the containing space, such that the rod body is ascended or descended by a resilience force of the resilient element;

a groove, situated at the rod body and formed on an external surface inside the containing space, for displacing and positioning the fixing element, and the groove including a slide section disposed in the same direction of an axis of the handle, a first guide section and a second guide section disposed at both ends of the slide section and extended in the same direction perpendicular to an axis of the slide section, a second position limiting slot extended in a direction from the second guide section towards the bottom of the handle, and a first position limiting slot extended from the first guide section and towards the same direction of the second position limiting slot, and the slide section, the first guide section, the second guide section, the second position limiting slot and the first position limiting slot are disposed continuously.

### BRIEF DESCRIPTION OF THE DRAWINGS

FIG. 1 is an exploded view of the present invention;

FIG. 2 is a perspective view of a rod body extended from a handle in accordance with the present invention;

FIG. 3 is a schematic view of a rod body situated in a handle completely in accordance with the present invention;

FIG. 4 is a schematic view of passing a rod body towards a containing space of a handle in accordance with the present invention; and

FIG. 5 is a schematic view of extending and protruding a rod body externally towards a containing space of a handle in accordance with the present invention.

### DETAILED DESCRIPTION OF THE PREFERRED EMBODIMENTS

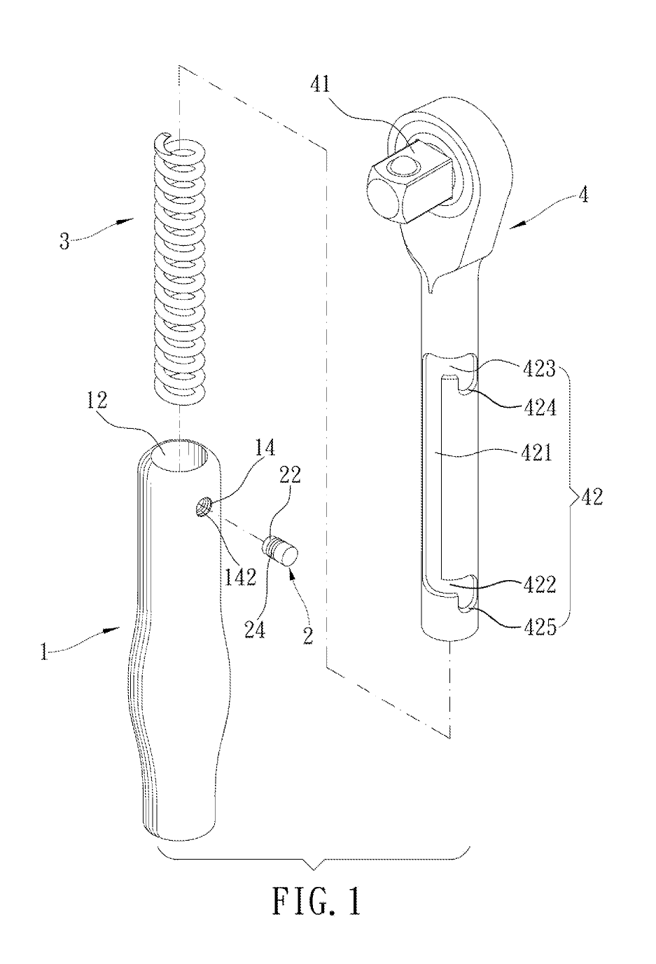

With reference to FIGS. 1 to 5 for a structure in accordance with a preferred embodiment of the present invention, the preferred embodiment is provided for illustrating the present invention only, but not intended for limiting the scope of the invention.

The preferred embodiment provides a contractible wrench structure as shown in FIGS. 1 to 3, and the contractible wrench structure comprises a handle 1, a resilient element 3, and a rod body 4.

The handle 1 includes a containing space 12 defined therein and interconnected to one end of the handle 1 only, and a hole 14 formed at an appropriate position of the handle 1 and proximate to the interconnected external surface for accommodating a fixing element 2. The fixing element 2 is protruded towards an end of the containing space 12 and extended into the containing space 12. In this preferred embodiment, the fixing element 2 includes a peg 22 disposed towards an end of the containing space 12, wherein the peg 22 is in a circular cylindrical shape.

In accordance with a preferred embodiment of the present invention, a screw-thread section 142 is formed at an internal periphery of the hole 14 of the handle 1, and a line pattern 24 is formed on an external surface of another end of the fixing element 2 and engaged with the screw-thread section 142 of the hole 1. The technical measure of screwing the fixing element 2 into the hole 14 for a fixation. However, the fixation method is not limited to such arrangement only.

The resilient element 3 is installed in the containing space 12, and an end of the resilient element 3 is abutted and stopped in the containing space 12, and another end of the resilient element is provided for propping the rod body 4 to ascend the rod body 4 to a predetermined height for a support action. In this preferred embodiment, the resilient element 3 is a spring.

The rod body 4 includes a driving head 41 disposed at an end of the rod body 4 and away from the containing space 12, and another end of the rod body 4 is contained in the containing space 12. With the resilience force of the resilient element 3, the rod body 4 can be ascended or descended. The rod body 4 further includes groove 42 formed on an external periphery in the containing space 12 and provided for displacing and fixing the peg 22 of the fixing element 2.

In FIG. 1, the groove 42 includes a slide section 421 disposed in the same direction of the axis of the handle 1, a first guide section 422 and a second guide section 423 disposed at both ends of the slide section 421 and extended in the same direction perpendicular to the axis of the slide section 421, a second position limiting slot 424 extended from the second guide section 423 towards the bottom of the handle 1, and a first position limiting slot 425 extended from the first guide section 422 towards the same direction of the second position limiting slot 424, wherein the slide section 421, the first guide section 422, the second guide section 423, the second position limiting slot 424 and the first position limiting slot 425 are disposed continuously.

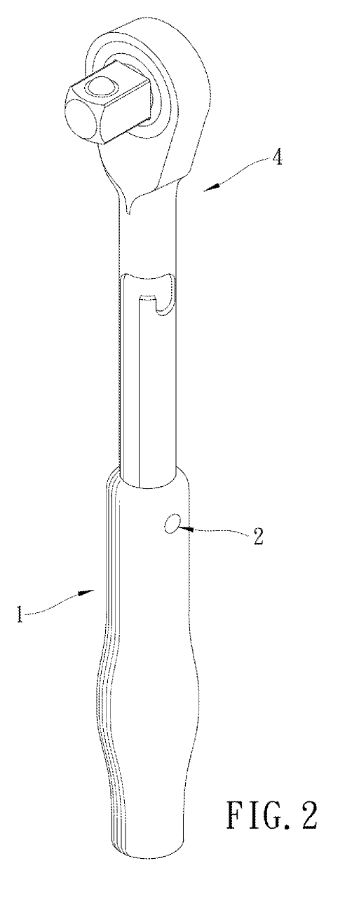

After the aforementioned components are assembled, the contractible wrench structure of the invention is formed. In a practical application of the present invention as shown in FIGS. 1 and 2, a vast majority of the rod body 4 is exposed from the containing space 12, since the resilience force of the resilient element 3 is extended outward to provide a vertical height for supporting and extending the rod body 4 out of the handle 1. In addition, the peg 22 of the fixing element 2 is always embedded and latched into the first position limiting slot 425, so that the rod body 4 can be extended and fixed.

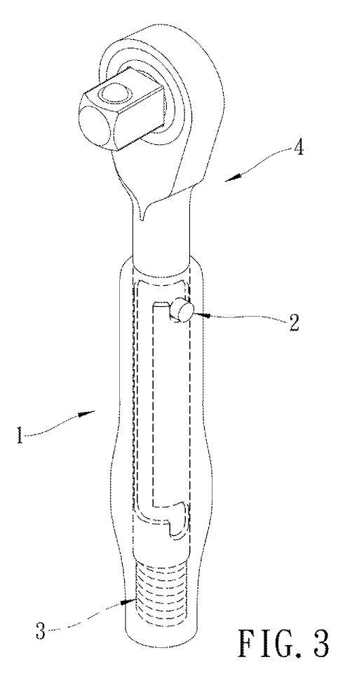

With reference to FIGS. 1 and 3, when the rod body 4 is retracted into the containing space 12 of the handle 1, the bottom of the rod body 4 is supported and abutted by the resilient element 3, and the peg 22 of the fixing element 2 is still latched into the second position limiting slot 424.

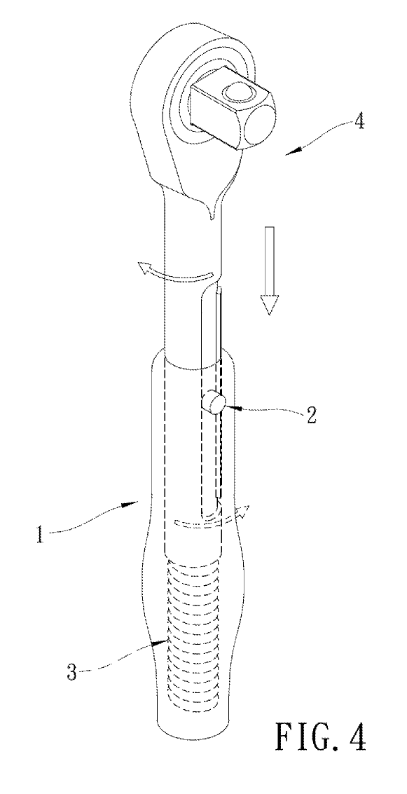

With reference to FIGS. 1 and 4, when a user wants to descent the rod body 4, the user can hold the handle 1 by one hand, and slightly press the rod body 4 down by the other hand, such that the peg 22 of the fixing element 2 is moved and separated from the first position limiting slot 425, and then the groove 42 of the rod body 4 is displaced into the first guide section 422, and the slide section 421 of the groove 42 is provided for moving the peg 22 upward, and then the peg 22 of the fixing element 2 is entered from the slide section 421 into the second guide section 423, and latched into the second position limiting slot 424 for completing the entire retraction process of the rod body 4. The left and right rotational arrows in FIG. 4 indicate the direction of rotating the rod body 4 during the process of retracting the rod body 4.

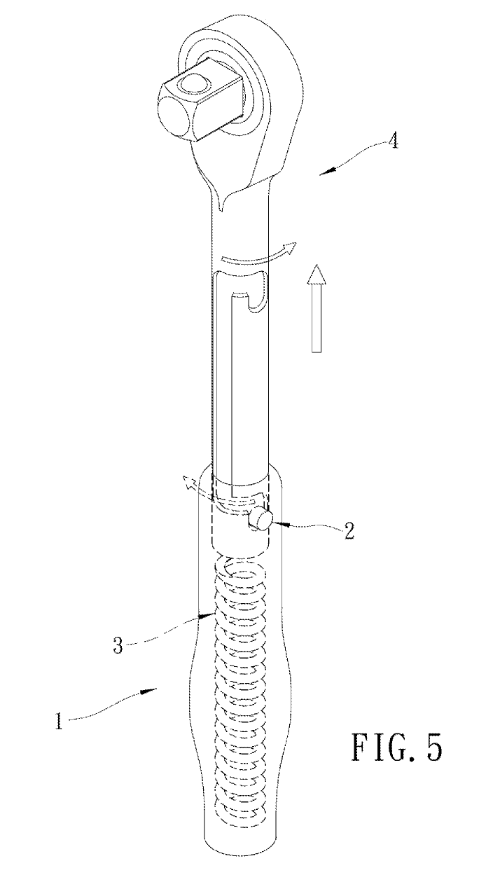

With reference to FIGS. 1 and 5, when the user wants to ascend the rod body 4, the user can also hold the handle 1 by one hand and slightly press the rod body 4 down by the other hand, such that the peg 22 of the fixing element 2 is moved and separated from the second position limiting slot 424, and then the rod body 4 is rotated to the second guide section 423, such that the peg 22 can be moved into the slide section 421, and then the peg 22 is entered into the first guide section 422, and finally moved and latched into the first position limiting slot 425. The left and right arrows in FIG. 5 refer to the direction of rotating the rod body 4 during the process of rotating the rod body 4.

In the present invention, the second guide section 423 and the second position limiting slot 424 of the rod body 4 and the first guide section 422 and the first position limiting slot 425 situated at the rod body 4 in the containing space 12 are designed in the same direction, so that a user can use both hands to hold the wrench structure between the handle 1 and the rod body 4, such that the peg 22 can be moved along the path of the groove 42 composed of the slide section 421, the first guide section 422, the second guide section 423, the second position limiting slot 424 and the first position limiting slot 425.

When a user operates the wrench to extend or contract between handle 1 and the rod body 4 or rotates the wrench to a fixed position, the user simply needs to move along the aforementioned groove 42 for a convenient operation, and thus the invention can overcome the problem of the conventional contractible wrench that cannot provide a correct operation for contracting or extending the wrench between the handle and the wrench body.

While the invention has been described by means of specific embodiments, numerous modifications and variations could be made thereto by those skilled in the art without departing from the scope and spirit of the invention set forth in the claims.

What is claimed is:

1. A contractible wrench stricture, comprising:
a handle, having a containing space defined therein and interconnected to one end of the handle only, and a hole formed at an appropriate position proximate to an interconnected external surface of the handle for installing a fixing element, and an end of the fixing element being protruded towards the containing space and extended into the containing space;
a resilient element, installed in the containing space, and an end of the resilient element being stopped inside the containing space;
a rod body, being propped by another end of the resilient element, and having a driving head disposed at an end of the rod body and away from the containing space, and another end of the rod body being contained into the containing space, such that the rod body is ascended or descended by a resilience force of the resilient element;
a groove, situated at the rod body and formed on an external surface inside the containing space, for displacing and positioning the fixing element, and the groove including a slide section disposed in the same direction of an axis of the handle, a first guide section and a second guide section disposed at both ends of the slide section and extended in the same direction perpendicular to an axis of the slide section, a second position limiting slot extended in a direction from the second guide section towards the bottom of the handle, and a first position limiting slot extended from the first guide section and towards the same direction of the second position limiting slot, and the slide section, the first guide section, the second guide section, the second position limiting slot and the first position limiting slot are disposed continuously.

2. The contractible wrench stricture of claim 1, further comprising a screw-thread section formed on an internal periphery of the hole of the handle, and a line pattern formed on an external surface at another end of the fixing element and engaged with the screw-thread section of the hole of the handle.

3. The contractible wrench structure of claim 1, wherein the peg of the fixing element is in a cylindrical shape.

4. The contractible wrench structure of claim 1, wherein the resilient element is a spring.
